(19) United States
(12) Patent Application Publication
(10) Pub. No.: US 2013/0113899 A1
(43) Pub. Date: May 9, 2013

(54) VIDEO PROCESSING DEVICE AND VIDEO PROCESSING METHOD

(71) Applicants: Toshihiro MOROHOSHI, Kawasaki-Shi (JP); Shinzo MATSUBARA, Tokyo (JP); Tatsuhiro NISHIOKA, Kawasaki-Shi (JP)

(72) Inventors: Toshihiro MOROHOSHI, Kawasaki-Shi (JP); Shinzo MATSUBARA, Tokyo (JP); Tatsuhiro NISHIOKA, Kawasaki-Shi (JP)

(73) Assignee: KABUSHIKI KAISHA TOSHIBA, Tokyo (JP)

(21) Appl. No.: 13/480,861

(22) Filed: May 25, 2012

(30) Foreign Application Priority Data
Nov. 4, 2011 (JP) 2011-242674

(51) Int. Cl. H04N 13/04; H04N 7/18

(52) U.S. Cl. 348/51; 348/77; 348/E07.085; 348/E13.075

(57) ABSTRACT

A video processing device has a viewer detector to recognize a face of a viewer using a video shot by a camera in order to acquire position information of the viewer, a subscreen display controller to superimpose a live video shot by the camera on a part of a display screen of a display device as a subscreen, a viewing area frame display controller to display, in the live video in the subscreen, a viewing area frame representing a viewing position where the viewer is viewable a stereoscopic video, and a face frame display controller to display a first face frame showing that the stereoscopic video is viewable when the viewer is located within the frame, and to display a second face frame showing that the stereoscopic video is not viewable when the viewer is located outside the frame.

### CROSS REFERENCE TO RELATED APPLICATIONS

This application is based upon and claims the benefit of priority from the prior Japanese Patent Application No. 2011-242674, filed on Nov. 4, 2011, the entire contents of which are incorporated herein by reference.

### FIELD

Embodiments of the present invention relate to a video processing device and a video processing method capable of adjusting a viewing area where a stereoscopic video is viewable.

### BACKGROUND

TV capable of displaying a stereoscopic video viewable with naked eye attracts attention. However, in such a TV, it may be impossible to obtain stereoscopic effect depending on the viewing position, and a viewer wishing to obtain a sufficient stereoscopic effect is required to move to the position where the stereoscopic effect is available. In particular, when a plurality of viewers exist, it is extremely annoying for each viewer to move to the position where the stereoscopic effect is available. Further, there is a likelihood that the viewer feels uneasy about whether the viewer is at an optimum position to obtain the stereoscopic effect, since each viewer have a different sense regarding the stereoscopic effect.

Accordingly, it may be conceivable to automatically adjust by TV a viewing area. However, it is not easy to automatically adjust the viewing area since the viewer does not always stay at the same position and the number of viewer is not always fixed. Realistically, there are many cases that the stereoscopic effect cannot be obtained by automatically adjusting the viewing area. In such a case, the viewer has to move needlessly on search for a suitable location and it may be difficult to easily enjoy the stereoscopic video in the end.

Further, a glassless conventional 3D TV does not have an effective means for informing each viewer about whether or not the viewer is at a position where stereoscopic effect is available. Accordingly, each viewer excessively moves searching for a more optimum position, and feels difficult to enjoy stereoscopic videos with ease.

### BRIEF DESCRIPTION OF THE DRAWINGS

FIG. 1 is an external view of a video display device 100 according to one embodiment.

FIG. 2 is a block diagram showing a schematic structure of the video display device 100.

FIG. 3 is a partial top view of a liquid crystal panel 1 and a lenticular lens 2.

FIG. 4 is a diagram showing an example of a viewing area.

FIG. 5 is a flow chart showing an example of processing operation performed by a video processing device 5 according to the present embodiment.

FIG. 6 is a plane view showing an example of a remote controller 50 operated by a viewer.

FIG. 7 is a diagram showing an example of a 3D viewing position check screen.

FIG. 8 is a diagram showing the display position of a subscreen.

FIG. 9 is a diagram showing an example of the 3D viewing position check screen after the viewing area has been adjusted.

FIG. 10 is a schematic diagram showing the relationship between the straight-line distance from the surface of the liquid crystal panel 1 and the viewing area.

FIG. 11 is a diagram showing an example of a test pattern screen 35.

### DETAILED DESCRIPTION

According to one embodiment, a video processing device has a viewer detector configured to recognize a face of a viewer using a video shot by a camera in order to acquire position information of the viewer whose face has been recognized, a subscreen display controller configured to superimpose a live video shot by the camera on a part of a display screen of a display device as a subscreen, a viewing area frame display controller configured to display, in the live video in the subscreen, a viewing area frame representing a viewing position where the viewer is viewable a stereoscopic video, and a face frame display controller configured to display a first face frame showing that the stereoscopic video is viewable when the viewer is located within the frame, and to display a second face frame showing that the stereoscopic video is not viewable when the viewer is located outside the frame.

Embodiments will now be explained with reference to the accompanying drawings.

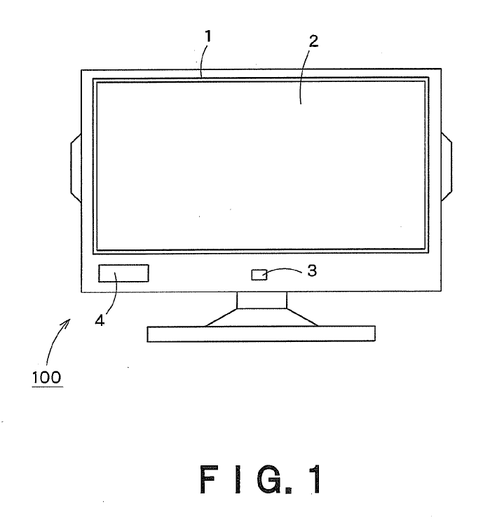

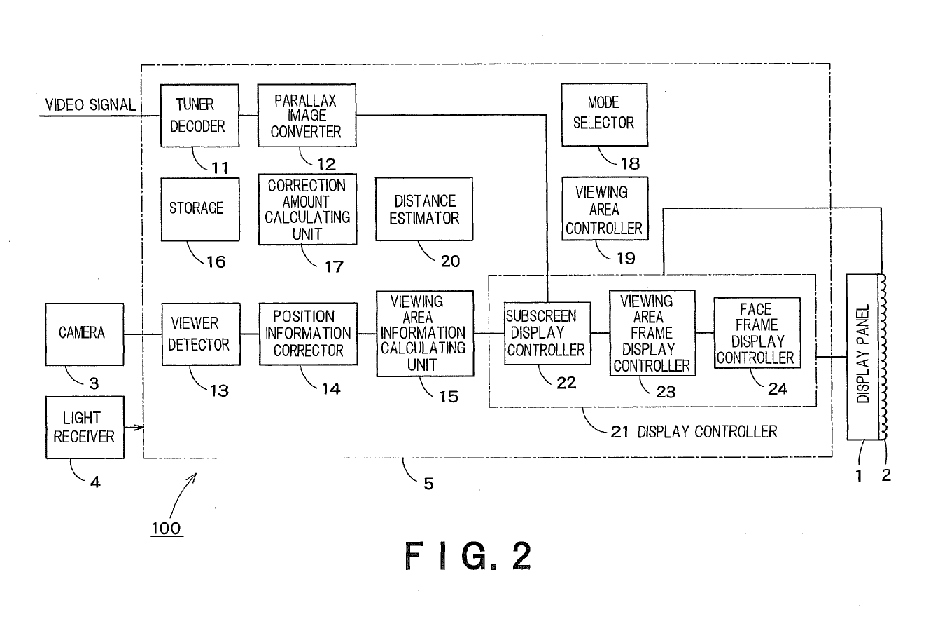

FIG. 1 is an external view of a video display device 100 according to one embodiment, and FIG. 2 is a block diagram showing a schematic structure thereof. The video display device 100 has a liquid crystal panel 1, a lenticular lens 2, a camera 3, a light receiver 4 and a video processing device 5.

The liquid crystal panel 1 can display parallax images so that a viewer can view a stereoscopic video. The liquid crystal panel 1 is a 55-inch panel having 11520 (=1280*9) pixels in the horizontal direction and 720 pixels in the vertical direction, for example. Further, each pixel consists of three subpixels, namely, an R subpixel, a G subpixel, and a B subpixel arranged in the vertical direction. The liquid crystal panel 1 is irradiated with light from a backlight device (not shown) arranged behind. Light having a brightness corresponding to a parallax image signal (to be explained later) supplied from the video processing device 5 is transmitted through each pixel.

The lenticular lens 2 outputs a plurality of parallax images displayed on the liquid crystal panel 1 in a direction corresponding to parallax. The lenticular lens 2 has a plurality of convexes arranged in the horizontal direction of the liquid crystal panel 1, and the number of convexes is 1/9 of the number of pixels arranged in the horizontal direction of the liquid crystal panel 1. The lenticular lens 2 is positioned to be attached to the surface of the liquid crystal panel 1 so that one convex corresponds to nine pixels arranged in the horizontal direction. Light transmitted through each pixel has a directivity and is outputted from near the top of the convex toward a specific direction.

The liquid crystal panel 1 of the present embodiment can display a stereoscopic video based on a multi-parallax video display mode (integral imaging method) with three or more parallaxes or on a two-parallax video display mode, in addition to a normal two-dimensional video. When displaying a two-dimensional video, optical effects of the lenticular lens 2 are apparently cancelled. Accordingly, the two-dimensional video can be displayed at a resolution higher than full HD.

Hereinafter, explanation will be given on an example where a multi-parallax video display mode is provided to display a stereoscopic video with nine parallaxes by assigning nine pixels to each convex of the liquid crystal panel 1. In this multi-parallax video display mode, first to ninth parallax images are displayed by every nine pixels each pixel corresponding to one convex. The first to ninth parallax images are images observed when a subject is viewed from nine viewpoints arranged in the horizontal direction of the liquid crystal panel 1. The viewer can stereoscopically view the video by viewing one of the first to ninth parallax images with the left eye while viewing another parallax image with the right eye, through the lenticular lens 2. In the multi-parallax video display mode, viewing area can be made broader by increasing the number of parallax images. The viewing area is an area where the video can be stereoscopically viewed when the liquid crystal panel 1 is viewed from the front position.

On the other hand, in the two-parallax video display mode, a right-eye parallax image is displayed through four pixels of nine pixels, and a left-eye parallax image is displayed through the other five pixels. The left-eye and right-eye parallax images are images observed when a subject is viewed from two viewpoints arranged in the horizontal direction as the left and right viewpoints, respectively. The viewer can stereoscopically view the video by viewing the left-eye parallax image with the left eye while viewing the right-eye parallax image with the right eye, through the lenticular lens 2. In the two-parallax video display mode, the video can be displayed more stereoscopically compared to the multi-parallax video display mode, but the viewing area is narrower compared to the multi-parallax video display mode.

Note that the liquid crystal panel 1 can also display a two-dimensional image by displaying the same image through nine pixels corresponding to each convex. In this case, resolution deteriorates, but the two-dimensional image can be displayed without cancelling optical effects of the lenticular lens 2. Therefore, a stereoscopic image and a two-dimensional image superimposed thereon can be displayed at the same time.

Further, in the present embodiment, the viewing area can be adjusted by controlling the relative positional relationship between the convex of the lenticular lens 2 and the parallax image to be displayed, namely, by controlling how to display parallax images through nine pixels corresponding to each convex. Hereinafter, the viewing area control will be explained considering the multi-parallax video display mode as an example.

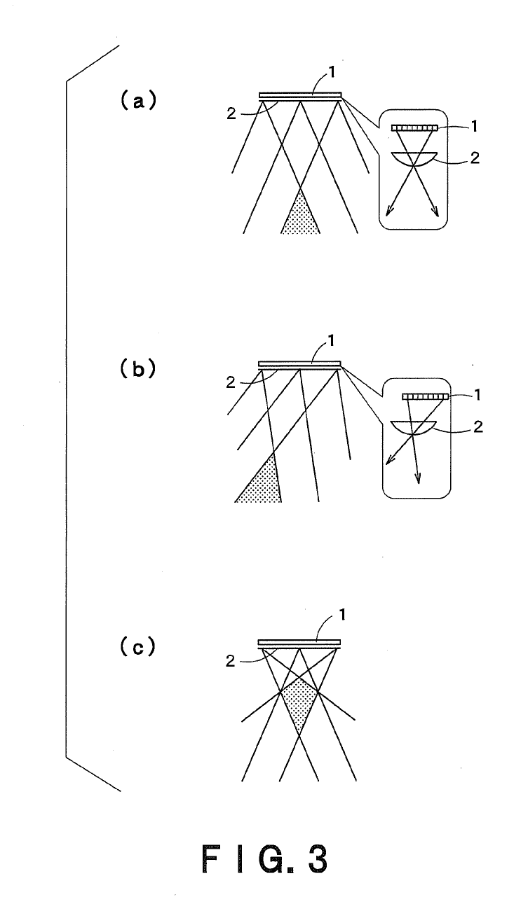

FIG. 3 is a partial top view of the liquid crystal panel 1 and the lenticular lens 2. In FIG. 3, the shaded area shows the viewing area, and a video can be stereoscopically viewed when the liquid crystal panel 1 is viewed from the viewing area. In the other area, pseudoscopic or crosstalk phenomenon is caused, which makes it difficult to stereoscopically view the video there.

FIG. 3 shows the relative positional relationship between the liquid crystal panel 1 and the lenticular lens 2, and more concretely, shows how the viewing area changes depending on the distance between the liquid crystal panel 1 and the lenticular lens 2 or the shift amount between the liquid crystal panel 1 and the lenticular lens 2 in the horizontal direction.

Actually, the lenticular lens 2 is positioned with high accuracy to be attached to the liquid crystal panel 1, and thus it is difficult to physically change the relative positional relationship between the liquid crystal panel 1 and the lenticular lens 2.

Accordingly, in the present embodiment, the viewing area is adjusted by shifting the position of the first to ninth parallax images displayed through each pixel of the liquid crystal panel 1 to change the apparent relative positional relationship between the liquid crystal panel 1 and the lenticular lens 2.

For example, compared to a case where the first to ninth parallax images are respectively displayed through nine pixels corresponding to each convex (FIG. 3(a)), the viewing area moves to the left when displaying the parallax images wholly shifted to the right (FIG. 3(b)). To the contrary, when displaying the parallax images wholly shifted to the left, the viewing area moves to the right.

Further, when the parallax images around the center in the horizontal direction are not shifted and the parallax images closer to the outer parts of the liquid crystal panel 1 are largely shifted outwardly (FIG. 3(c)), the viewing area moves to the direction approaching the liquid crystal panel 1. Note that each pixel between the shifted parallax image and unshifted parallax image or between parallax images having different shift amounts should be properly interpolated depending on its peripheral pixels. Further, contrary to FIG. 3(c), when the parallax images around the center in the horizontal direction are not shifted and the parallax images closer to the outer parts of the liquid crystal panel 1 are largely shifted inwardly, the viewing area moves to the direction receding from the liquid crystal panel 1.

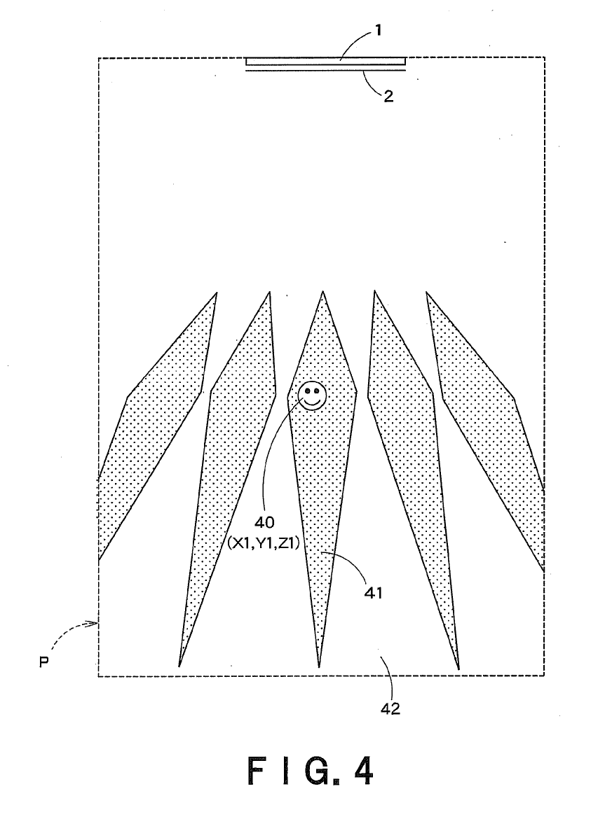

In this way, the viewing area can be moved in the right and left directions or in the back and forth directions with respect to the liquid crystal panel 1 by displaying the parallax images wholly or partially shifted. In FIG. 3, only one viewing area is shown for simple explanation, but actually a plurality of viewing areas 41 exist in a viewer area P as shown in FIG. 4, and the viewing areas simultaneously move. The viewing area is controlled by the video processing device 5 of FIG. 2 (mentioned later). Note that the viewer area except for the viewing areas 41 is a pseudoscopic area 42, where pseudoscopic or crosstalk phenomenon is caused, and thus it is difficult to stereoscopically view a fine video there.

As shown in FIG. 4, the viewing area roughly has a diamond shape. In the present embodiment, five kinds of viewing areas are previously prepared corresponding to the distances from the liquid crystal panel 1, in order to simplify the process. The details of the viewing area will be mentioned later.

Referring back to FIG. 2, each component of the video display device 100 will be explained.

The camera 3 is installed around the lower center of the liquid crystal panel 1 at a predetermined elevation, and shoots a predetermined range in front of the liquid crystal panel 1. The video shot by the camera 3 is supplied to the video processing device, and used to detect viewer information concerning the position, face, etc. of the viewer. The camera 3 may shoot any one of a moving image and a still image.

The light receiver 4 is arranged on the lower left side of the liquid crystal panel 1, for example. The light receiver 4 receives an infrared signal transmitted from a remote controller used by the viewer. This infrared signal includes signals showing whether the video to be displayed is a stereoscopic video or a two-dimensional video, and showing, when displaying a stereoscopic video, whether the mode to be employed is the multi-parallax video display mode or the two-parallax video display mode and whether the viewing area should be controlled.

Next, the internal structure of the video processing device 5 will be explained in detail. As shown in FIG. 2, the video processing device 5 has a tuner decoder 11, a parallax image converter 12, a viewer detector 13, a position information corrector 14, a viewing area information calculating unit 15, a storage 16, a correction amount calculating unit 17, a mode selector 18, a viewing area controller 19, a distance estimator 20 and a display controller 21.

The video processing device 5 is mounted as one or more ICs (Integrated Circuits) for example, and arranged behind the liquid crystal panel 1. Certainly, a part of the video processing device 5 may be implemented as software.

The tuner decoder (receiver) 11 receives and selects the broadcast wave to be inputted, and decodes an encoded video signal. When a data broadcasting signal concerning an electronic program guide (EPG) etc. is superposed on the broadcast wave, the tuner decoder 11 extracts the signal. Further, the tuner decoder 11 can receive and decode an encoded video signal transmitted from a video output device such as an optical disk reproducing device and a personal computer, instead of the broadcast wave. The decoded signal is called a baseband video signal, and supplied to the parallax image converter 12. When the video display device 100 does not receive any broadcast wave and displays only a video signal received from the video output device, a decoder for simply fulfilling the decoding function may be arranged as a receiver, instead of the tuner decoder 11.

The video signal to be received by the tuner decoder 11 may be a two-dimensional video signal or may be a three-dimensional video signal including left-eye and right-eye images based on Frame Packing (FP) method, Side By Side (SBS) method, Top And Bottom (TAB) method, etc. Further, the video signal may be a multi-parallax three-dimensional video signal covering three or more parallaxes.

In order to stereoscopically display the video, the parallax image converter 12 converts the baseband video signal into a plurality of parallax image signals, and supplies the signals to the display controller 21. The processing performed by the parallax image converter 12 differs depending on which one of the multi-parallax video display mode and the two-parallax video display mode is selected. Further, the processing performed by the parallax image converter 12 differs depending on whether the baseband video signal is a two-dimensional video signal or a three-dimensional video signal.

The mode selector 18 selects either a single user mode for adjusting the viewing area for a single viewer located around the center of the display device or a multiple user mode for adjusting the viewing area for a plurality of viewers located within the field angle of the camera.

As display modes of the display device, there are a two-dimensional video display mode for displaying a two-dimensional video, a two-parallax video display mode for displaying a two-parallax stereoscopic video and a multi-parallax video display mode for displaying a multi-parallax video covering three or more parallaxes. When the two-dimensional video display mode is selected, the adjustment of the viewing area is not necessary and thus the selection made by the mode selector 18 is disregarded. On the other hand, when the two-parallax video display mode is selected, the mode selector 18 automatically selects the single user mode. This is because the viewing area in the two-parallax video display mode is extremely narrow, and it is difficult to adjust the viewing area for a plurality of viewers. Further, when the multi-parallax video display mode is selected, it is possible to let the viewer select any one of the single user mode and the multiple user mode, or to automatically select the multiple user mode.

The parallax image converter 12 performs an image conversion process in accordance with the mode selected by the mode selector 18. For example, when the mode selector 18 selects the two-parallax video display mode, the parallax image converter 12 generates a left-eye parallax image signal and a right-eye parallax image signal corresponding to a left-eye parallax image and a right-eye parallax image respectively. More concretely, the following operation is performed.

When the two-parallax video display mode is selected and a three-dimensional video signal including left-eye and right-eye images is inputted, the parallax image converter 12 generates left-eye and right-eye parallax image signals in the format enabling the signals to be displayed on the liquid crystal panel 1. Further, when a three-dimensional video signal including three or more parallax images is inputted, the parallax image converter 12 generates left-eye and right-eye parallax image signals using arbitrary two of the images, for example.

On the other hand, when the two-parallax video display mode is selected and a two-dimensional video signal without any parallax information is inputted, the parallax image converter 12 generates left-eye and right-eye parallax image signals based on the depth value of each pixel in the video signal. The depth value is a value showing how far each pixel should be displayed frontward or backward from the liquid crystal panel 1. The depth value may be previously added to the video signal, or may be generated by performing motion detection, composition identification, human face detection, etc. based on the characteristics of the video signal. In the left-eye parallax image, the pixel viewed on the front side should be displayed with being shifted to the right compared to the pixel viewed on the back side. Therefore, the parallax image converter 12 generates the left-eye parallax image signal by performing a process of shifting the pixel viewed on the front side in the video signal to the right. The shift amount is increased as the depth value becomes larger.

When the multi-parallax video display mode is selected, the parallax image converter 12 generates first to ninth parallax image signals corresponding to first to ninth parallax images. More concretely, the following operation is performed.

When the multi-parallax video display mode is selected and a three-dimensional video signal including a two-dimensional video signal or eight or less parallax images is inputted, the parallax image converter 12 generates the first to ninth parallax image signals based on the depth information, as in the case of generating left-eye and right-eye parallax image signals from a two-dimensional video signal.

When the multi-parallax video display mode is selected and a three-dimensional video signal including nine parallax images is inputted, the parallax image converter 12 generates the first to ninth parallax image signals using the video signal.

The viewer detector 13 performs face recognition using the video shot by the camera 3, and acquires the position information of the viewer. This position information is supplied to the position information corrector 14 and the correction amount calculating unit 17 (mentioned later). Note that the viewer detector 13 can track the viewer even when the viewer moves, which makes it possible to grasp the viewing time of each viewer.

The position information of the viewer is expressed as a position on the X-axis (horizontal direction), Y-axis (vertical direction), and Z-axis (direction perpendicular to the liquid crystal panel 1), using the center of the liquid crystal panel 1 as the origin, for example. The position of a viewer 40 is expressed as the coordinate (X1, Y1, Z1). More concretely, the viewer detector 13 firstly recognizes a viewer by detecting a face in the video shot by the camera 3. Then, the viewer detector 13 calculates the position on the X-axis and the Y-axis (X1, Y1) based on the position of the face in the video, and calculates the position on the Z-axis (Z1) based on the size of the face. When a plurality of viewers exist, the viewer detector 13 may detect the positions of a predetermined number of viewers (e.g., ten people). In this case, when the number of detected faces is larger than 10, the positions of ten viewers closest to the liquid crystal panel 1, namely having smallest distances on the Z-axis, are sequentially detected, for example.

The viewing area information calculating unit 15 calculates a control parameter for setting the viewing area covering the detected viewer, using the viewer position information supplied from the position information corrector 14 (mentioned later). This control parameter shows e.g., a shift amount for the parallax images explained in FIG. 3, and one parameter or a combination of a plurality of parameters are used. Then, the viewing area information calculating unit 15 supplies the calculated control parameter to the display controller 21.

More concretely, in order to set a desired viewing area, the viewing area information calculating unit 15 uses a viewing area database in which a control parameter and the viewing area set by the control parameter are related to each other. This viewing area database is previously stored in the storage 16. The viewing area information calculating unit 15 searches the viewing area database to find the viewing area covering most of the face of the viewer.

In order to control the viewing area, the display controller 21 performs the adjustment of shifting and interpolating the parallax image signal depending on the calculated control parameter, and supplies the signal to the liquid crystal panel 1. The liquid crystal panel 1 displays an image corresponding to the adjusted parallax image signal.

The position information corrector 14 corrects the viewer position information acquired by the viewer detector 13 using the correction amount calculated by the correction amount calculating unit 17 (mentioned later), and supplies the corrected position information to the viewing area information calculating unit 15. When the calculation of the correction amount is not completed, the position information corrector 14 supplies the viewer position information acquired by the viewer detector 13 directly to the viewing area information calculating unit 15.

The storage 16 is a nonvolatile memory such as a flash memory, and the viewing area database, correction amount for position information, etc. are stored therein. Note that the storage 16 may be arranged outside the video processing device 5.

The correction amount calculating unit 17 calculates a correction amount for compensating an error in the viewer position information caused by a gap in the position where the camera 3 is installed. As will be explained in detail later, this correction amount can be calculated by (a) changing the output directions of the parallax images without forcing the viewer to move, and (b) forcing the viewer to move without changing the output directions of the parallax images. Here, the gap in the installation position includes a gap in the installation direction of the camera 3 (gap in the optical axis.)

In more detail, the display controller 21 has a subscreen display controller 22, a viewing area frame display controller 23 and a face frame display controller 24. The subscreen display controller 22 superimposes the video shot by the camera 3 on a part of the display screen of the display device, as a subscreen. The viewing area frame display controller 23 displays viewing area frames in the subscreen. The face frame display controller 24 displays, in the subscreen, a mark showing whether or not the viewer is located within the viewing area.

As stated above, explanation has been made on the internal structure of the video display device 100. In the example shown in the present embodiment, the lenticular lens 2 is used and the viewing area is controlled by shifting the parallax images. However, the viewing area may be controlled by another technique. For example, a parallax barrier may be arranged instead of the lenticular lens 2. In this case, the viewing area is controlled by using the parallax barrier to control the output directions of the parallax images displayed on the liquid crystal panel 1.

As stated above, when the lenticular lens 2 is used, the viewing area is adjusted by shifting the parallax image data supplied to each pixel of the liquid crystal panel 1, while when the parallax barrier is used, the viewing area is adjusted by directly controlling the parallax barrier.

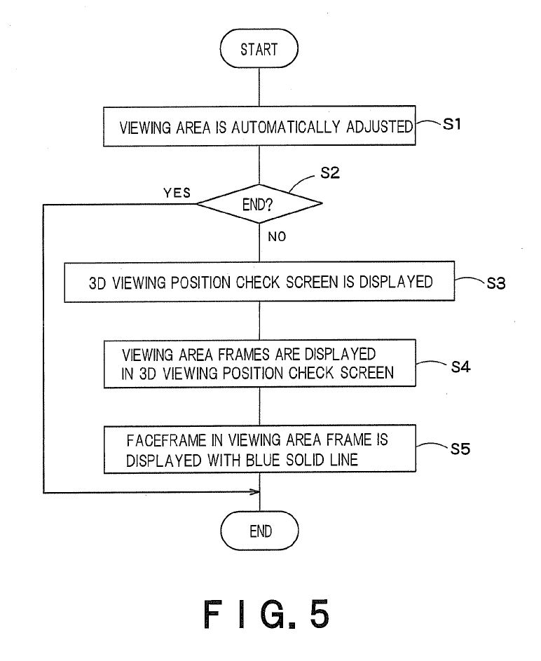

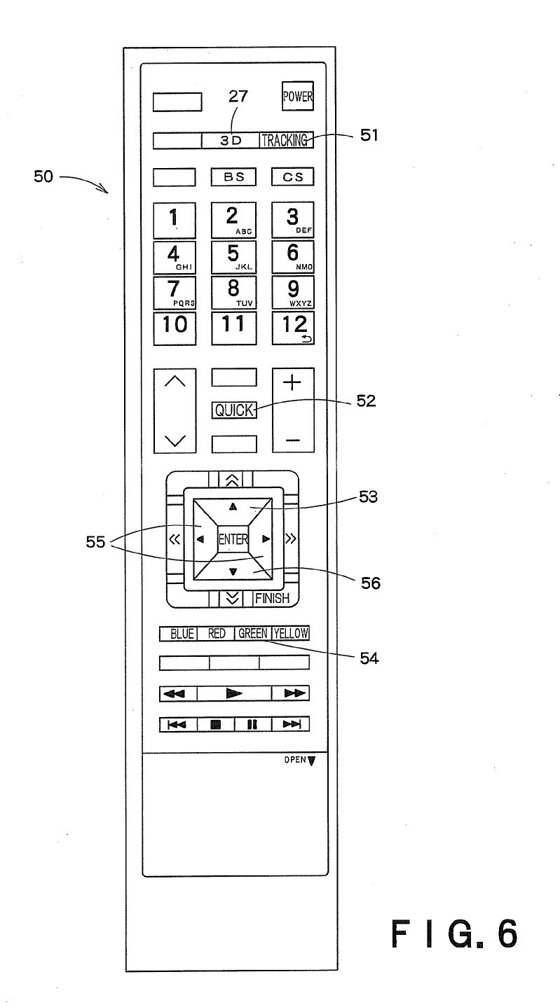

FIG. 5 is a flow chart showing an example of processing operation of the video processing device 5 according to the present embodiment, and FIG. 6 is a plane view showing an example of a remote controller 50 operated by the viewer. The flow chart of FIG. 5 starts when a tracking button 51 of the remote controller 50 is pushed.

Before starting this flow chart, the viewer must select any one of the two-parallax video display mode and the multi-parallax video display mode by the remote controller 50. When the two-dimensional video display mode is selected, the adjustment of the viewing area is not necessary and thus the process of FIG. 5 is omitted. The following explanation is based on the assumption that the single user mode is selected when the two-parallax video display mode is selected, and the multiple user mode is selected when the multi-parallax video display mode is selected.

When the tracking button 51 is pushed, the viewing area is automatically adjusted (Step S1). Here, the camera 3 shoots viewers located in front of the liquid crystal panel 1. When the multi-parallax video display mode is selected, the distance from the surface of the liquid crystal panel 1 to each viewer shot by the camera 3 is estimated. This distance is estimated by the distance estimator 20. The distance estimator 20 estimates the distance from the surface of the liquid crystal panel 1 based on the face size of the viewer shot by the camera 3. Then, the viewing area is adjusted by shifting the parallax image while controlling the output timing of the parallax image data so that each viewer is located within the viewing area. When the two-parallax video display mode is selected, a viewer located around the front of the liquid crystal panel 1 is detected and the distance between the viewer and the liquid crystal panel 1 is estimated, and then the viewing area is adjusted so that this viewer is located within the viewing area.

If the viewing area has been satisfactorily adjusted by the automatic tracking adjustment at Step 51, the process of FIG. 5 is ended (YES at Step S2). If the viewing area has not been satisfactorily adjusted, a “3D viewing position check” screen is displayed by operating a quick button 52 of the remote controller 50 and further operating up/down buttons 53 (Step S3).

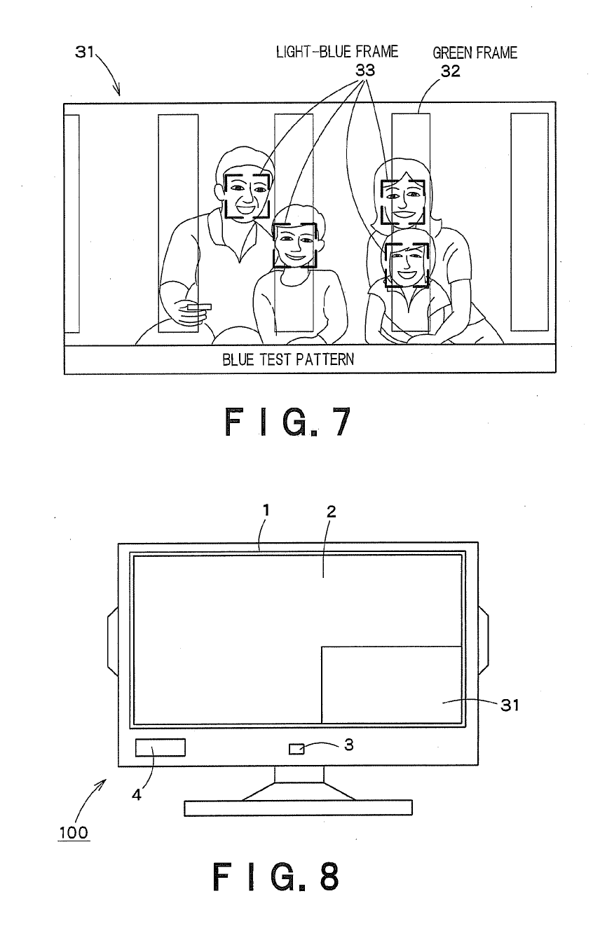

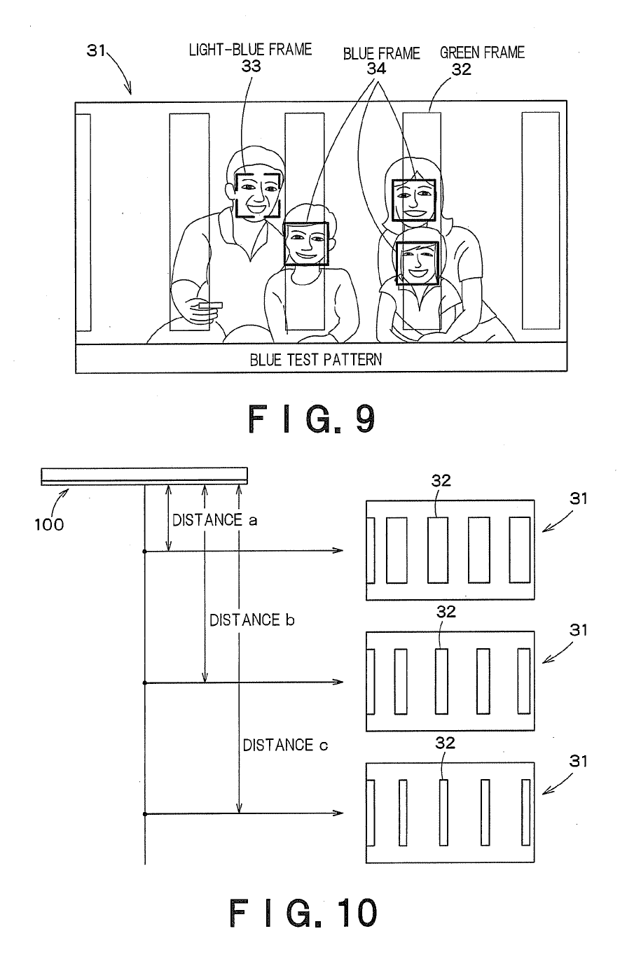

FIG. 7 is a diagram showing an example of the 3D viewing position check screen. In this 3D viewing position check screen, the live video being shot by the camera 3 is shown. This 3D viewing position check screen is superimposed on the stereoscopic video being displayed on the liquid crystal panel 1, as a subscreen 31.

The subscreen 31 is displayed near the camera 3, and as shown in FIG. 8, displayed in the lower right part of the display screen of the liquid crystal panel 1, for example. It is desirable that the subscreen 31 is arranged closer to the camera 3 as much as possible, since the viewer adjusts the viewer's position while checking its own figure displayed on the subscreen 31. That is, it is more desirable that the optical axis of the camera 3 and the direction of eyes of the viewer watching the subscreen 31 are close to each other as much as possible, so that the viewer can search an optimum position without any discomfort.

Note that the live video of the camera 3 displayed in the subscreen 31 is a two-dimensional video without any parallax information. A stereoscopic video is displayed in the background of the subscreen 31, and the two-dimensional video is partially displayed in the stereoscopic video. In order to realize this display, it is required that the coordinate position range of the subscreen 31 in the display screen is previously acquired and all of nine pixels serving as a unit for displaying a stereoscopic video are supplied with the same pixel data in the acquire coordinate position range. In this way, a two-dimensional video can be displayed in the subscreen 31 while displaying a stereoscopic video. The display of the subscreen 31 is controlled by the subscreen display controller 22 of FIG. 1.

As shown in FIG. 7, the 3D viewing position check screen displayed in the subscreen 31 shows viewing area frames 32 each showing a range where the stereoscopic video is viewable (Step S4). These frames 32 are displayed while being superimposed on the live video being shot by the camera 3. Further, a light-blue dotted-line frame 33 is displayed around the face of each viewer recognized by the live video.

Each viewer changes the viewer's viewing position so that the viewer's face is located within the range of the viewing area frame 32 in the 3D viewing position check screen. More concretely, each viewer moves the viewer's face so that the light-blue dotted-line frame 33 displayed around the viewer's face is completely within the viewing area frame 32. In this case, it is premised that a plurality of viewers adjust their viewing areas, and thus each viewer moves into any one of the viewing area frames 32 in the 3D viewing position check screen.

When the face frame 33 of the viewer whose viewing area should be adjusted is within the viewing area frame 32, the face frame 33 changes to a blue solid-line frame 34, and the adjustment of the viewing area is completed (Step S5). If a sufficient stereoscopic effect is obtained, the adjustment of the viewing area is finished by pushing a quit button of the remote controller 50.

The storage 16 stores plural kinds of viewing area information corresponding to the straight-line distances from the surface of the liquid crystal panel 1. FIG. 10 is a schematic diagram showing the relationship between the straight-line distance from the surface of the liquid crystal panel 1 and the viewing area. In the example of FIG. 10, the storage 16 stores viewing area information concerning straight-line distances a, b, and c from the surface of the liquid crystal panel 1. As shown in FIG. 10, the width of the viewing area becomes larger as the straight-line distance from the surface of the liquid crystal panel 1 becomes smaller. Note that the width of the viewing area in each case is set to about 16 cm, which is the average facial width of the viewers. That is, the actual width of the viewing area does not change regardless of the straight-line distance from the surface of the liquid crystal panel 1. Since the viewer is displayed smaller as the viewer is farther from the surface of the liquid crystal panel 1, the width of the viewing area becomes smaller.

In FIG. 10, the storage 16 stores viewing area information concerning three distances a, b, and c as an example. However, the viewing area information concerning a greater number of distances may be stored.

As shown in FIG. 10, the storage 16 stores the viewing area information corresponding to the straight-line distances from the surface of the liquid crystal panel 1, and thus the stored information is based on the viewing areas with intervals therebetween. For example, in FIG. 10, when the viewer is located between the distance “a” and the distance “b”, the distance to the viewer is estimated by the camera 3, and viewing area information of the distance “a” or “b” closer to the estimated distance is read from storage 16 to display the viewing area frames 32 on the subscreen 31.

Further, when the viewer is located far from the liquid crystal panel 1, the viewer cannot view any stereoscopic effect, and thus it is desirable to prompt the viewer to move by displaying a mark (e.g., an arrow) showing the moving direction for the viewer on the subscreen 31.

If the adjustment of the viewing area using the 3D viewing position check screen shown in FIG. 7 is not enough to obtain a sufficient stereoscopic effect, the viewing area can be adjusted by the viewing area controller 19 by operating a blue button 54 of the remote controller 50, for example.

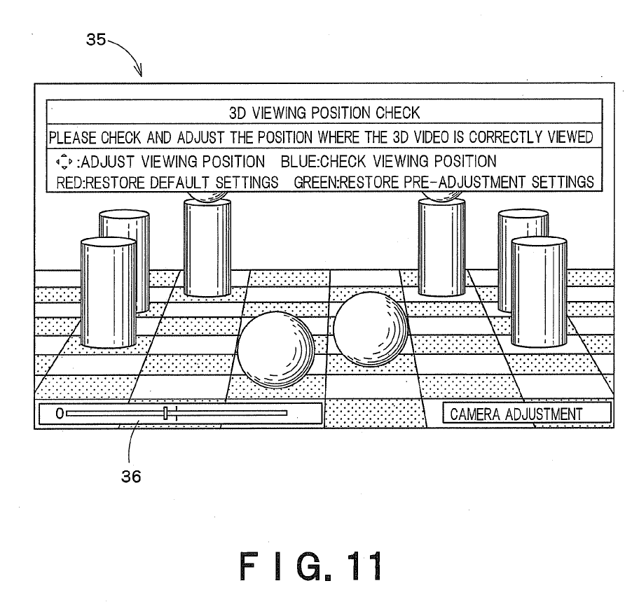

FIG. 11 is a diagram showing an example of a test pattern screen 35. The test pattern screen 35 displayed in the entire display screen of the liquid crystal panel 1 is formed of parallax images to display a stereoscopic image. A slide bar 36 is arranged in this screen, and how the stereoscopic video is seen from the right and left directions can be adjusted by operating the slide bar 36 with right/left keys 55 of the remote controller 50, for example. Further, the distance from the liquid crystal panel 1 can be adjusted by operating the up/down keys 53 of the remote controller 50.

When the right/left keys 55 or the up/down keys 53 of the remote controller 50 are operated, the correction amount calculating unit 17 of FIG. 1 calculates a correction amount for the viewer position information, and stores it in the storage 16. The position information corrector 14 supplied with the viewer position information from the viewer detector 13 reads the correction amount for the position information from the storage 16, and corrects the position information supplied from the viewer detector 13 using this correction amount. The corrected position information is supplied to the display controller 21.

The display controller 21 calculates a control parameter using the corrected position information, and determines the display position of each pixel of the parallax image data using this control parameter. Then, the parallax image data is supplied to each pixel of the liquid crystal panel 1.

As stated above, in the present embodiment, when the automatic adjustment of the viewing area based on face tracking is not enough to obtain a sufficient stereoscopic effect, the viewer can adjust the viewing area by displaying the 3D viewing position check screen depending on the viewer's needs. In the 3D viewing position check screen, the viewing area frames 32 are displayed while displaying the face frame 33 of the viewer recognized by the camera 3, and the viewer is prompted to move so that the face frame 33 of the viewer is within the viewing area frame 32. Accordingly, the video processing device 5 is not required to change the field angle of the camera 3 and to adjust the viewing area, which reduces the processing load of the video processing device 5. The viewer can move to an optimum position where stereoscopic effect is available watching the viewing area frames 32 and the face frame 33 in the subscreen 31 superimposed on the display screen of the liquid crystal panel 1. Accordingly, the viewer can move to an optimum viewing position simply and quickly without worrying about where to move.

Further, when the 3D viewing position check screen is also not enough to obtain a sufficient stereoscopic effect, the test pattern screen 35 is further displayed to adjust the viewing area by the video processing device 5, which makes it possible to optimally adjust the viewing area without forcing the viewer to change the viewer's viewing position.

At least a part of the video processing device 5 explained in the above embodiments may be formed of hardware or software. In the case of software, a program realizing at least a partial function of the video processing device 5 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the video processing device 5 can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A video processing device comprising:
a viewer detector configured to recognize a face of a viewer using a video obtained by a camera to acquire position information of the viewer;
a subscreen display controller configured to superimpose a live video obtained by the camera on a part of a display screen of a display device, the part of the display screen comprising a subscreen;
a viewing area frame display controller configured to display, in the live video in the subscreen, a viewing area frame representing a viewing position where a stereoscopic video is viewable by the viewer; and
a face frame display controller configured to display a first face frame showing that the stereoscopic video is viewable when the viewer is located within the frame, and to display a second face frame showing that the stereoscopic video is not viewable when the viewer is located outside the frame.

2. The device of claim 1,
wherein the camera is at a lower center of the display screen of the display device, and
the subscreen display controller displays the subscreen near the camera.

3. The device of claim 1,
wherein a width of the viewing area frame corresponds to an average facial width for the viewer.

4. The device of claim 1, further comprising:
a frame storage configured to store one or more types of viewing area frames based on a straight-line distance from the display device to the viewer; and
a distance estimator configured to estimate the straight-line distance from the display device to the viewer based on the video obtained by the camera,
wherein the viewing area frame display controller reads, from the frame storage, the viewing area frame corresponding to a straight-line distance closest to the straight-line distance estimated by the distance estimator, and displays it in the subscreen.

5. The device of claim 1, further comprising:
a distance estimator configured to estimate the straight-line distance from the display device to the viewer based on the video obtained by the camera,
wherein the face frame display controller is configured to display the first face frame when the straight-line distance estimated by the distance estimator is within a specific range, and to display the second face frame when the straight-line distance estimated by the distance estimator is not within the specific range.

6. The device of claim 5,
wherein the face frame display controller displays a sign indicating a direction in which the viewer should move when the straight-line distance estimated by the distance estimator is now within the specific range.

7. The device of claim 1,
wherein the subscreen display controller draws the subscreen by supplying two-dimensional image data without parallax information to respective pixels of the display device corresponding to a display range of the subscreen.

8. The device of claim 1, further comprising:
a mode selector configured to select a single user mode for adjusting the viewing area when a single viewer is located around a center of the display device and to select a multiple user mode for adjusting the viewing area when a plurality of viewers are located within a field angle of the camera,
wherein the face frame display controller displays the first face frame or the second face frame in accordance with the mode selected by the mode selector.

9. The device of claim 8, further comprising:
a video type detector configured to detect a video type of input video data,
wherein the mode selector selects either the single user mode or the multiple user mode based, at least in part, on the video type of the input video data detected by the video type detector.

10. The device of claim 9,
wherein the mode selector selects the single user mode when displaying a stereoscopic video by supplying, to respective pixels of the display device, two-parallax data generated using parallax information or depth information included in the input video data, and enables the viewer to select one of the single user mode and the multiple user mode when displaying a stereoscopic video by supplying, to respective pixels of the display device, multi-parallax data of three or more parallaxes.

11. The device of claim 1, further comprising:
a check screen generator configured to generate a test pattern screen including a left-eye parallax image and a right-eye parallax image; and
a viewing area controller configured to adjust the viewing area using the test pattern screen to enable the viewer to view the stereoscopic video with both eyes.

12. A video processing method, comprising:
when a viewer selects, by an operating device, an automatic adjustment option for a viewing area, obtaining an image of the viewer using a camera, estimating a straight-line distance between the viewer and a display device based on the image, and adjusting the viewing area so that the viewer is located within a viewing area where a stereoscopic video is viewable;
when the viewer selects, by the operating device, an arbitrary adjustment option for the viewing area, displaying a subscreen with a live video obtained by the camera on a part of a display screen of the display device; and
displaying a first face frame showing that the stereoscopic video is viewable when the viewer is located within the frame, and displaying a second face frame showing that the stereoscopic video is not viewable when the viewer is located outside the frame.

13. The method of claim 12,
wherein the camera is at a lower center of the display screen of the display device, and
displaying the subscreen further comprises displaying the subscreen near the camera.

14. The method of claim 12,
wherein a width of the viewing area frame corresponds to an average facial width for the viewer.

15. The method of claim 12, further comprising:
storing in a frame storage one or more types of viewing area frames based on a straight-line distance from the display device to the viewer; and
estimating the straight-line distance from the display device to the viewer based on the video obtained by the camera, wherein displaying the subscreen further comprises reading, from the frame storage, the viewing area frame corresponding to a straight-line distance closest to the straight-line distance estimated by the distance estimator, and displays it in the subscreen.

16. The method of claim 12, further comprising:
estimating the straight-line distance from the display device to the viewer based on the video obtained by the camera,
wherein displaying the second face further comprises displaying the first face frame when the estimated straight-line distance is within a specific range, and displaying the second face frame when the estimated straight-line distance is not within the specific range.

17. The device of claim 16,
wherein displaying the second face further comprises displaying a sign indicating a direction in which the viewer should move when the estimated straight-line distance is not within the specific range.

18. The method of claim 12,
wherein displaying the subscreen further comprises drawing the subscreen by supplying two-dimensional image data without parallax information to respective pixels of the display device corresponding to a display range of the subscreen.

19. The method of claim 12, further comprising:
selecting a single user mode for adjusting the viewing area when a single viewer is located around a center of the display device and selecting a multiple user mode for adjusting the viewing area when a plurality of viewers are located within a field angle of the camera,
wherein displaying the second face frame further comprises displaying the first face frame or the second face frame in accordance with the selected mode.

20. The method of claim 19, further comprising:
detecting a video type of input video data,
wherein either the single user mode or the multiple user mode is selected based, at least in part, on the video type of the input video data detected by the video type detector.
